(19) United States
(12) Patent Application Publication
(10) Pub. No.: US 2011/0137547 A1
(43) Pub. Date: Jun. 9, 2011

(54) SYSTEM AND METHOD FOR GENERATING SPATIAL INFORMATION

(75) Inventors: Seung Joon KWON, Seoul (KR); Sung Woong SHIN, Daejeon (KR)

(73) Assignee: Electronics and Telecommunications Research Institute, Daejeon (KR)

(21) Appl. No.: 12/905,185

(22) Filed: Oct. 15, 2010

(30) Foreign Application Priority Data
Dec. 3, 2009 (KR) 10-2009-0119300
Apr. 14, 2010 (KR) 10-2010-0034479

(51) Int. Cl. G01C 21/00

(52) U.S. Cl. 701/200; 701/213; 701/214

(57) ABSTRACT

A system for generating spatial information using an unmanned aerial vehicle may collect area information of an area where the unmanned aerial vehicle is located, obtain image information of the area where the unmanned aerial vehicle is located, and integrate a time code into the image information. Next, the system for generating spatial information may map integrated information in which the time code is integrated into the image information and the area information, and generate three-dimensional (3D) spatial information including a true orthophoto generated by performing a true ortho-correction for a mapping result.

### CROSS-REFERENCE TO RELATED APPLICATION

This application claims priority to and the benefit of Korean Patent Application No. 10-2009-0119300 and 10-2010-0034479 filed in the Korean Intellectual Property Office on Dec. 3, 2009 and Apr. 14, 2010, the entire contents of which are incorporated herein by reference.

### BACKGROUND OF THE INVENTION

(a) Field of the Invention

The present invention relates to a system and method for generating spatial information. More particularly, the present invention relates to a system and method for generating three-dimensional (3D) spatial information based on an unmanned aerial vehicle (UAV).

(b) Description of the Related Art

An aerial image may be classified into a manned aerial image obtained using an airplane where a man is on board, or an unmanned aerial image obtained using an airplane where no man is on board.

Initially, in the case of an image obtainment system using the manned aerial image, a sensor modeling process is complex and a large manual operation is needed and thus it may be ineffective. Also, in the case of the image obtainment system using the manned aerial image, there is a drawback that it is difficult to obtain geographical and spatial information with respect to a desired location at a desired time belonging to a bad weather.

The airplane where no man is on board is referred to as an unmanned aerial vehicle (hereinafter, “UAV”). A system using the above UAV (hereinafter, “UAV system”) is generally used for a surveillance or a reconnaissance.

A corresponding area of the UAV system may be classified into a reconnaissance & surveillance (hereinafter, RS) area for an RS, and a control area for control.

In the RS area, the UAV system may collect information of a major target using a UAV. However, in the UAV system operated for purpose of the RS, a processor of automatically generating collected information as three-dimensional (3D) geographical information does not exist.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for generating spatial information having advantages of generating, as three-dimensional (3D) spatial information, information obtained using a unmanned aerial vehicle (UAV).

An exemplary embodiment of the present invention provides a method for generating spatial information using a UAV, including:

collecting area information of an area where the unmanned aerial vehicle is located; integrating a time code into the collected image information of the area where the unmanned aerial vehicle is located; mapping integrated information in which the time code is integrated into the image information and the area information; and generating spatial information including a true orthophoto by performing a true ortho-correction for a result of the mapping.

Another embodiment of the present invention provides a system for generating spatial information using a UAV, including:

a navigation for collecting area information of an area where the unmanned aerial vehicle is located;

a data obtainment unit for obtaining image information of the area where the unmanned aerial vehicle is located form the navigation, and integrating a time code into the image information;

a data processor for mapping integrated information in which the time code is integrated into the image information to the area information; and

a spatial information output unit for generating spatial information including a true orthophoto by performing a true ortho-correction for a result of the mapping.

Yet another embodiment of the present invention provides a system for generating spatial information using a UAV, including:

a data obtainment unit for obtaining image information of an area where the unmanned aerial vehicle is located, and integrating a time code into the image information; a data processor for mapping integrated information in which the time code is integrated into the image information to area information received from an outside; and a spatial information output unit for generating 3D spatial information including a true orthophoto by performing a true ortho-correction for a mapping result.

### BRIEF DESCRIPTION OF THE DRAWINGS

FIG. 1 is a diagram schematically illustrating a system for generating spatial information according to an exemplary embodiment of the present invention;

FIG. 2 is a block diagram illustrating a configuration of a system for generating spatial information according to an exemplary embodiment of the present invention; and

FIG. 3 is a flowchart illustrating a method for generating spatial information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, In addition, unless explicitly described to the contrary, the word “comprise” and variations such as “comprises” or “comprising”, will be understood to imply the inclusion of stated elements but not the exclusion of any other elements.

Hereinafter, a system and method for generating spatial information according to an exemplary embodiment of the present invention will be described with reference to the accompanying drawings.

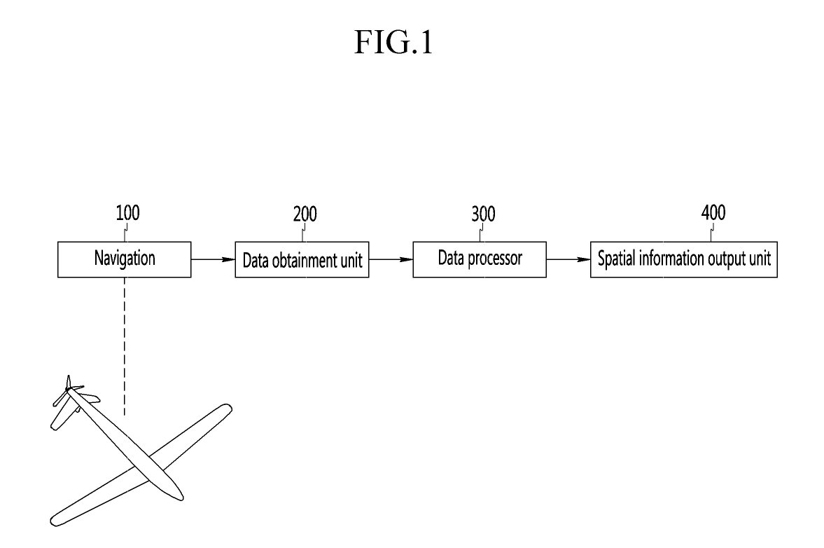

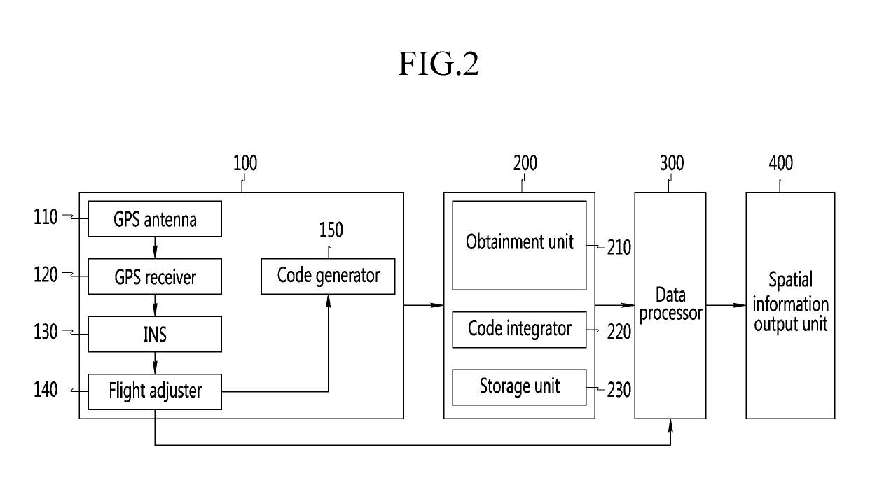

FIG. 1 is a diagram schematically illustrating a system for generating spatial information according to an exemplary embodiment of the present invention, and FIG. 2 is a block diagram illustrating a configuration of a system for generating spatial information according to an exemplary embodiment of the present invention.

As shown in FIG. 1, the system for generating spatial information may include a navigation 100, a data obtainment unit 200, a data processor 300, and a spatial information output unit 400.

The navigation 100 may collect area information associated with a corresponding area based on a global positioning system (hereinafter, “GPS”) and an inertial navigation system (hereinafter, “INS”). Here, the area information may include raw data of the GPS and the INS.

The navigation 100 according to an exemplary embodiment of the present invention may be combined with an unmanned aerial vehicle (hereinafter, “UAV”), however, is not limited thereto.

As shown in FIG. 2, the navigation 100 may include a GPS antenna 110, a GPS receiver 120, an INS 130, a flight adjuster 140, and a code generator 150.

The GPS antenna 110 may be positioned on a fuselage of a UAV.

The GPS receiver 120 may receive a GPS satellite signal via the GPS antenna 110.

The INS 130 may detect a flight location of the UAV where the UAV is currently located.

The flight adjuster 140 may correct a flight error of the flight location detected by the INS 130 based on the GPS satellite signal. In this instance, the flight adjuster 140 may transfer, to the data processor 300, area information including a flight attitude of the UAV, flight location information, and the like. Here, the flight location information is information corresponding to a corrected flight location.

The code generator 150 may generate a time code that is a criterion to indicate a predetermined time or a location of particular information. In this instance, the time code may decrease a time error according to an obtainment of image information and a transmission and reception processing of the image information.

The data obtainment unit 200 may obtain image information of an area where the UAV is located, and integrate the time code into the obtained image information and thereby store the time code. For this purpose, the data obtainment unit 200 may include an obtainment unit 210, a code integrator 220, and a storage unit 230.

The obtainment unit 210 may include a means to obtain image information of a corresponding area, for example, a digital aerial camera and a laser scanner. In this instance, the digital aerial camera corresponds to a component obtaining a UAV aerial image (UAV image sequences), and the laser scanner corresponds to a component obtaining laser scanner information including digital elevation model (hereinafter, “DEM”) information.

Also, the obtainment unit 210 may be installable in a camera mount of the UAV, however, is not limited thereto.

The code integrator 220 may store a time code corresponding to image information obtained by the obtainment unit 210 or encode and then integrate the time code into the corresponding image information.

The storage unit 230 may store integrated information in which the image information and the time code are integrated.

The data processor 300 may perform a direct orientation processing process of mapping the integrated information and the area information. Next, the data processor 300 may transfer, to the spatial information output unit 400, a mapping result of mapping the integrated information and the area information.

The spatial information output unit 400 may generate 3D spatial information including a true orthophoto obtained by performing a true ortho-correction for the mapping result based on the DEM information.

According to an exemplary embodiment of the present invention, the system for generating spatial information may quickly output 3D spatial information without a process of manually inputting a ground control point or a complex processing process such as an aerotriangulation scheme.

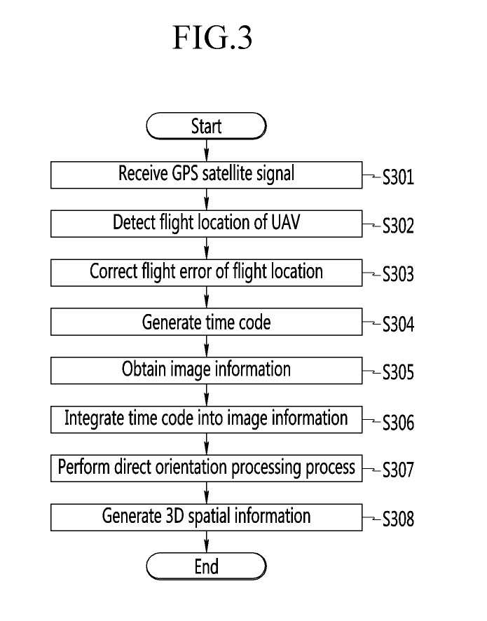

Hereinafter, a method for generating spatial information according to an exemplary embodiment of the present invention will be described with reference to FIG. 3.

FIG. 3 is a flowchart illustrating a method for generating spatial information according to an exemplary embodiment of the present invention.

Initially, a system for generating spatial information according to an exemplary embodiment of the present invention may be combined with a UAV, however, is not limited thereto. Also, a means for obtaining image information, GPS equipments (GPS antenna 110 and GPS receiver 120), and the INS 130, included in the spatial information generating system, may be provided in a form to be separate from the spatial information generating system.

As shown in FIG. 3, the system for generating spatial information may receive a GPS satellite signal via the GPS antenna 110 (S301), and detect a flight location of the UAV (S302). The system for generating spatial information may correct a flight error of the flight location detected based on the GSP satellite signal (S303).

The system for generating spatial information may generate a time code that is a criterion to indicate location information including a corrected flight location (S304).

The system for generating spatial information may obtain image information of an area where the UAV is located, using a means such as a digital aerial camera and a laser scanner (S305). In this instance, the digital aerial camera may obtain UAV aerial image information, and the laser scanner may obtain DEM information.

Next, the system for generating spatial information may integrate a corresponding time code into the obtained image information by storing or encoding the corresponding time code into the obtained image information (S306). In this instance, information in which the corresponding time code is integrated into the image information is integrated information.

The system for generating spatial information may perform a direct orientation processing process (S307). Specifically, the system for generating spatial information may map the integrated information and area information including flight location information.

The system for generating spatial information may generate 3D spatial information including a true orthophoto obtained by performing a true ortho-correction for the mapping result based on the DEM information (S308).

Specifically, according to an exemplary embodiment of the present invention, a method for generating spatial information may reconfigure image information of an area where a UAV is located, using a means such as a digital aerial camera and a laser scanner, and may generate 3D spatial information using area information generated based on a GPS and an INS and image information.

According to an exemplary embodiment of the present invention, it is possible to generate 3D image information based on a global positioning system (GPS)/inertial navigation system (INS) and a direct orientation processing process, instead of applying a ground point control and an aerotriangulation scheme. The method for generating spatial information may decrease a cost and an operation time used when generating image information based on the ground control point and the aerotriangulation scheme.

Also, according to an exemplary embodiment of the present invention, even in an emergency where a ground control point does not exist such as a forest fire or an oil spill, it is possible to monitor a ground in real time by generating, as 3D spatial information, information obtained by a UAV system.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for generating spatial information using an unmanned aerial vehicle, comprising:
collecting area information of an area where the unmanned aerial vehicle is located;
integrating a time code into the collected image information of the area where the unmanned aerial vehicle is located;
mapping integrated information in which the time code is integrated into the image information and the area information; and
generating spatial information including a true orthophoto by performing a true ortho-correction for a result of the mapping.

2. The method of claim 1, wherein:
the collecting of the area information includes,
receiving a satellite signal from an outside;
detecting a flight location of the unmanned aerial vehicle;
generating the time code corresponding to a criterion indicating the flight location; and
collecting the area information by correcting a flight error of the flight location based on the satellite signal.

3. The method of claim 2, wherein:
the collecting of the area information collects the area information based on a global positioning system (GPS) and an inertial navigation system (INS).

4. The method of claim 1, wherein:
the integrating of the time code into the image information
encodes the time code and integrates the encoded time code into the image information.

5. The method of claim 4, wherein:
the image information includes an aerial image photographed from the unmanned aerial vehicle and laser scanner information.

6. The method of claim 1, wherein:
the generating of the spatial information includes,
performing a true ortho-correction for the result of mapping based on a digital elevation model including the image information; and
generating three-dimensional (3D) spatial information including the true orthophoto generated by performing the true ortho-correction.

7. A system for generating spatial information using an unmanned aerial vehicle, comprising:
a navigation for collecting area information of an area where the unmanned aerial vehicle is located;
a data obtainment unit for obtaining image information of the area where the unmanned aerial vehicle is located form the navigation, and integrating a time code into the image information;
a data processor for mapping integrated information in which the time code is integrated into the image information to the area information; and
a spatial information output unit for generating spatial information including a true orthophoto by performing a true ortho-correction for a result of the mapping.

8. The system of claim 7, wherein:
the navigation includes,
a receiver for receiving a satellite signal using an antenna;
a detector for detecting a flight location of the unmanned aerial vehicle; and
a flight adjuster for correcting a flight error of the flight location based on the satellite signal.

9. The system of claim 8, further comprising:
a code generator for generating the time code corresponding to a criterion indicating the flight location.

10. The system of claim 7, wherein:
the data obtainment unit includes,
an obtainment unit for obtaining the image information using a digital aerial camera and a laser scanner;
a code integrator for encoding a time code corresponding to the image information and integrating the encoded time code into the image information; and
a storage unit for storing integrated information in which the time code is integrated into the image information.

11. The system of claim 10, wherein:
the digital aerial camera obtains an aerial image of the unmanned aerial vehicle, and
the laser scanner obtains a digital elevation model.

12. The system of claim 11, wherein the data processor performs a true ortho-correction for the result for mapping based on the digital elevation model.

13. The system of claim 11, wherein:
the spatial information output unit generates three-dimensional (3D) spatial information.

14. A system for generating spatial information using an unmanned aerial vehicle, comprising:
a data obtainment unit for obtaining image information of an area where the unmanned aerial vehicle is located, and integrating a time code into the image information;
a data processor for mapping integrated information in which the time code is integrated into the image information to area information received from an outside; and
a spatial information output unit for generating three-dimensional (3D) spatial information including a true orthophoto by performing a true ortho-correction for a mapping result.

15. The system of claim 14, wherein:
the data obtainment unit includes,
an obtainment unit for obtaining the image information using a digital aerial camera and a laser scanner;
a code integrator for encoding a time code corresponding to the image information and integrating the encoded time code into the image information; and
a storage unit for storing integrated information in which the time code is integrated into the image information.

16. The system of claim 14, wherein:
the area information is received from a navigation installed in the unmanned aerial vehicle.

17. The system of claim 16, wherein:
the navigation includes,
a receiver for receiving a satellite signal using an antenna;
an inertial navigation system (INS) for detecting a flight location of the unmanned aerial flight; and
a flight adjuster for correcting a flight error of the flight location based on the satellite signal.
